(19) United States
(12) Patent Application Publication
(10) Pub. No.: US 2026/0019173 A1
(43) Pub. Date: Jan. 15, 2026

(54) MESH NETWORKING FOR POSITIONING AND NAVIGATION

(71) Applicant: QUALCOMM Incorporated, San Diego, CA (US)

(72) Inventors: Hongguang HU, Shanghai (CN); Bing SUN, Shanghai (CN); Huanan QIU, Shanghai (CN)

(21) Appl. No.: 18/992,055

(22) PCT Filed: Aug. 24, 2022
(86) PCT No.: PCT/CN2022/114432

§ 371 Date: Jan. 7, 2025

(51) Int. Cl. H04B 17/318; H04W 64/00

(52) U.S. Cl. CPC H04B 17/318; H04W 64/00

(57) ABSTRACT

This disclosure provides methods, devices and systems for wireless positioning. An example method includes determining a first received signal strength indicator (RSSI) signature, the first RSSI signature including a respective RSSI associated with each access point (AP) of a first plurality of APs, where the first plurality of APs form at least a portion of a mesh network of APs, comparing the first RSSI signature with each reference RSSI signature of a first plurality of reference RSSI signatures, each reference RSSI signature of the first plurality of reference RSSI signatures including a respective RSSI associated with each AP of the first plurality of APs, and identifying a first position of the wireless STA based on the comparing of the first RSSI signature.

### CROSS REFERENCE

The present application is a 371 national phase filing of International PCT Application No. PCT/CN2022/114432 by HU et al., entitled “MESH NETWORKING FOR POSITIONING AND NAVIGATION,” filed Aug. 24, 2022, which is assigned to the assignee hereof, and which is expressly incorporated by reference in its entirety herein.

### TECHNICAL FIELD

This disclosure relates generally to wireless communication, and more specifically, to the use of mesh networking for positioning and navigation within a structure or grid such as a parking garage or lot.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

Parking structures are common within large, populated areas. It may be difficult in a large parking structure for users to identify and navigate to nearby empty parking spaces, particularly when the parking structure is nearly full.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication. The method includes determining a first received signal strength indicator (RSSI) signature, the first RSSI signature including a respective RSSI associated with each access point (AP) of a first plurality of APs, the first plurality of APs forming at least a portion of a mesh network of APs, comparing the first RSSI signature with each reference RSSI signature of a first plurality of reference RSSI signatures, each reference RSSI signature of the first plurality of reference RSSI signatures including a respective RSSI associated with each AP of the first plurality of APs, and each reference RSSI signature associated with a respective potential position of the wireless STA, and identifying a first position of the wireless STA based on the comparing of the first RSSI signature.

Another innovative aspect of the subject matter described in this disclosure can be implemented in a wireless station (STA). The wireless STA includes at least one processor, and at least one memory communicatively coupled with the at least one processor and storing processor-readable code. Execution of the processor-readable code by the at least one processor causes the wireless STA to perform operations including determining a first received signal strength indicator (RSSI) signature, the first RSSI signature including an RSSI associated with each access point (AP) of a first plurality of APs, the first plurality of APs forming at least a portion of a mesh network of APs, comparing the first RSSI signature with each reference RSSI signature of a first plurality of reference RSSI signatures, each reference RSSI signature of the first plurality of reference RSSI signatures including a respective RSSI associated with each AP of the first plurality of APs, and each reference RSSI signature associated with a respective potential position of the wireless STA, and identifying a first position of the wireless STA based on the comparing of the first RSSI signature.

In some implementations, each reference RSSI signature of the first plurality of reference RSSI signatures is associated with corresponding grid coordinates within a grid of positions proximate to the first plurality of APs. In some implementations, identifying the first position of the wireless STA includes associating the wireless STA with first grid coordinates within the grid of positions based on the comparing of the first RSSI signature. In some aspects, identifying the first position of the wireless STA further includes selecting a first reference RSSI signature of the first plurality of RSSI signatures based on the comparing and associating the wireless STA with grid coordinates associated with the first reference RSSI signature. In some aspects, the comparing of the first RSSI signature includes determining a Euclidean distance between the first RSSI signature and each reference RSSI signature of the first plurality of reference RSSI signatures, where the first reference RSSI signature is the reference RSSI signature having the shortest Euclidean distance from the first RSSI signature.

In some implementations, the methods and wireless STAs may be configured to identify second grid coordinates within the grid of positions corresponding to an empty parking space and causing the display of a navigation route from the first position of the wireless STA to the empty parking space. In some aspects, the methods and wireless STAs may be configured to determine a second RSSI signature, the second RSSI signature including a respective RSSI associated with each AP of a second plurality of APs, where the second plurality of APs form at least a portion of the mesh network, comparing the second RSSI signature with each reference RSSI signature of a second plurality of reference RSSI signatures, each reference RSSI signature of the second plurality of reference RSSI signatures including an RSSI associated with a respective AP of the second plurality of APs, and identifying a second position of the wireless STA based on the comparing of the second RSSI signature. In some aspects, the methods and wireless STAs may be configured to determine that the second position of the wireless STA corresponds to the second grid coordinates and setting the second grid coordinates to correspond to an occupied parking space.

In some aspects, the methods and wireless STAs may be configured to determine that the first position of the wireless STA corresponds to an occupied parking space and causing the display of a navigation route from the first position of the wireless STA to exit coordinates within the grid of positions. In some aspects, the exit coordinates indicate an exit of a parking structure associated with the grid of positions.

Another innovative aspect of the subject matter described in this disclosure can be implemented in a method for generating position signatures for positions within a grid of positions. An example method includes identifying a first plurality of access points (APs) having at least a threshold received signal strength indicator (RSSI), the first plurality of APs forming at least a portion of a mesh network of APs, measuring a first plurality of RSSIs, the first plurality of RSSIs including a respective RSSI associated with each AP of the first plurality of APs, and generating a first reference RSSI signature corresponding to first grid coordinates within the grid of positions, the first reference RSSI signature generated based at least in part on the first plurality of RSSIs.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 shows a pictorial diagram of an example wireless communication network.

FIG. 2 shows a pictorial diagram of another example wireless communication network.

FIG. 3 shows a block diagram of an example wireless communication device.

FIG. 4A shows a block diagram of an example access point (AP).

FIG. 4B shows a block diagram of an example station (STA).

FIG. 5A shows a simplified overhead view of a parking area, in accordance with the example implementations.

FIG. 5B shows a simplified overhead view of a parking area, in accordance with the example implementations.

FIG. 6 shows a flowchart illustrating an example process that supports wireless positioning according to some implementations.

FIG. 7 shows a flowchart illustrating an example process that supports generating a reference received signal strength indication (RSSI) signature according to some implementations.

FIG. 8 shows a flowchart illustrating an example process that supports positioning and navigation, according to some implementations.

FIG. 9 shows a flowchart illustrating an example process that supports positioning and navigation, according to some implementations.

FIG. 10 shows a block diagram of an example wireless communication device that supports wireless positioning and navigation according to some implementations.

FIG. 11 shows a block diagram of an example wireless communication device that supports wireless positioning and navigation according to some implementations.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU)-MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IoT) network.

Various aspects relate generally to the use of mesh networking to identify a position of a station (STA) located within a vehicle within a parking structure or lot based on the strengths of signals received from nearby access points (APs) of a mesh network, and to provide navigation aid to the STA to direct it and the vehicle towards an empty space in the parking structure or area. In some examples, the STA may be a special purpose STA configured for positioning and navigation within parking structures or areas. For example, a user may be provided with such a special purpose STA upon entry to the parking structure or area, in order to aid the user in identifying and navigating to an empty parking space within the parking structure or area. In some examples, the STA determines the position based on measuring received signal strength indications (RSSIs) of signals received from a plurality of APs nearby the STA in the parking structure or area. In some other examples, a central AP of the plurality of APs may determine the position of the STA based on the RSSIs measured by the STA. In some such examples, the STA or the central AP may compare a set of RSSIs measured by the STA (an “RSSI signature”) to a number of sets of reference RSSI measurements (where each set may be referred to herein as a “reference RSSI signature”) in order to identify the position of the STA. In some examples, the position may be expressed in terms of grid coordinates, within a grid of positions. Further, each reference RSSI signature is associated with a specific position which may be defined with respect to the grid of positions. That is, each reference RSSI signature includes a plurality of RSSI measurements each of which are associated with grid coordinates indicating the specific position. In some such examples, the STA or the central AP determines the position of the STA as the grid coordinates associated with the reference RSSI signature having the smallest Euclidean distance from the RSSIs measured by the STA. The STA may then present navigation instructions, or cause a display within the vehicle to display directions, such as directions for navigating to an empty parking space or to an exit of the parking structure or lot.

Particular aspects of the subject matter described in this disclosure can be implemented to realize one or more of the following potential advantages. In some examples, the described techniques can be used to provide increased efficiency and effectiveness to the process of parking a vehicle in a parking structure by identifying open parking spaces near the vehicle and providing navigation directions to the open parking spaces. This may limit the amount of time a user of the vehicle may drive around within the parking structure, saving the user time, and reducing traffic for other users within the parking structure. Further, aspects of the present disclosure may allow for such navigation even in the absence of satellite or cellular navigation, as often a STA may be unable to receive satellite or cellular signals within a large parking structure.

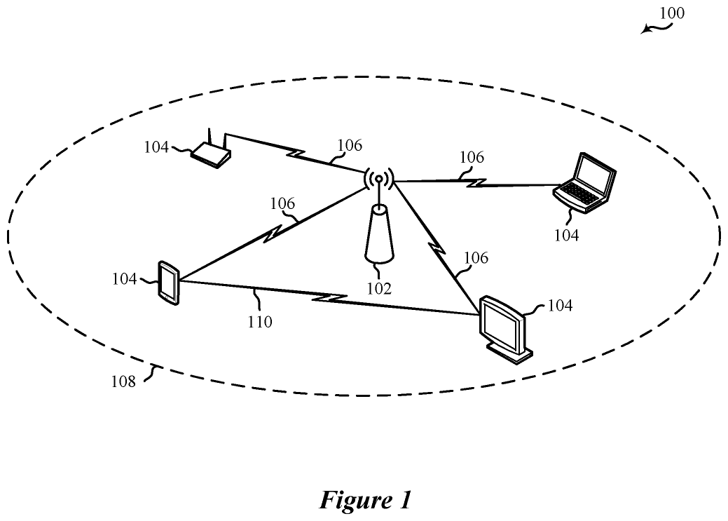

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be). The WLAN 100 may include numerous wireless communication devices such as an access point (AP) 102 and multiple stations (STAs) 104. While only one AP 102 is shown, the WLAN network 100 also can include multiple APs 102.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples.

A single AP 102 and an associated set of STAs 104 may be referred to as a basic service set (BSS), which is managed by the respective AP 102. FIG. 1 additionally shows an example coverage area 106 of the AP 102, which may represent a basic service area (BSA) of the WLAN 100. The BSS may be identified to users by a service set identifier (SSID), as well as to other devices by a basic service set identifier (BSSID), which may be a medium access control (MAC) address of the AP 102. The AP 102 periodically broadcasts beacon frames (“beacons”) including the BSSID to enable any STAs 104 within wireless range of the AP 102 to “associate” or re-associate with the AP 102 to establish a respective communication link 108 (hereinafter also referred to as a “Wi-Fi link”), or to maintain a communication link 108, with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 108.

To establish a communication link 108 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link 108 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such implementations, while the STAs 104 may be capable of communicating with each other through the AP 102 using communication links 108, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 108) according to the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be). These standards define the WLAN radio and baseband protocols for the PHY and medium access control (MAC) layers. The APs 102 and STAs 104 transmit and receive wireless communications (hereinafter also referred to as “Wi-Fi communications”) to and from one another in the form of PHY protocol data units (PPDUs) (or physical layer convergence protocol (PLCP) PDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or CCC20 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

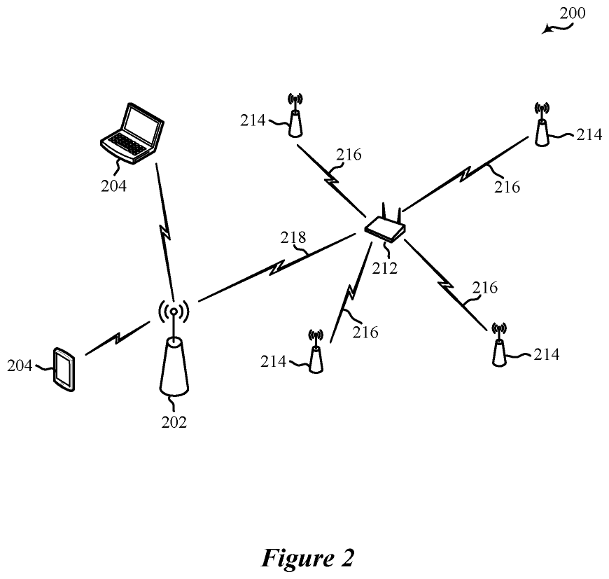

FIG. 2 shows a pictorial diagram of another example wireless communication network 200. According to some aspects, the wireless communication network 200 can be an example of a mesh network which may be used with the implementations of the present disclosure. The wireless network 200 may include multiple dedicated wireless stations 214. The dedicated wireless stations 214 may represent various special purpose stations, such as stations associated with the parking structure, and configured to be placed within vehicles navigating and parking within the parking structure, among other examples. For example, each dedicated wireless station 214 may be disposed on a dashboard of a vehicle, or in another location within a vehicle.

In some implementations, the dedicated wireless stations 214 communicate with intermediate devices 212 for subsequent processing or distribution. Additionally or alternatively, the intermediate devices 212 may transmit control information, navigation information, digital content (for example, audio or video data), configuration information or other instructions to the dedicated wireless stations 214. The intermediate devices 212 and the dedicated wireless stations 214 can communicate with one another via wireless links 216. In some implementations, the wireless links 216 include Wi-Fi, or another suitable wireless communication protocol. More particularly with respect to the present disclosure, the intermediate devices 212 may include a plurality of APs 212 positioned throughout a parking structure and used for determining a position of a dedicated wireless station 214 based on signals received from at least a portion of the plurality of intermediate devices 212.

In some examples, the intermediate devices 212 also may be configured for wireless communication with other networks such as with a Wi-Fi WLAN or a wireless (for example, cellular) wide area network (WWAN), which may, in turn, provide access to external networks including the Internet. For example, the intermediate devices 212 may be configured to associate and communicate, over a Wi-Fi link 218, with an AP 202 of a WLAN network, which also may serve various STAs 204. In some implementations, the intermediate device 212 is an example of a network gateway, for example. In such a manner, the intermediate device 212 may serve as an edge network bridge providing a Wi-Fi core backhaul for the network including the dedicated wireless stations 214. In some implementations, the intermediate devices 212 can be configured to analyze, preprocess and aggregate data received from the dedicated wireless stations 214 locally at the edge before transmitting it to other devices or external networks via the Wi-Fi link 218. The intermediate device 212 also can be configured to provide additional security for the network and the data it transports. More particularly with respect to the present disclosure, the AP 202 may be a central AP which may process signals measured by the dedicated wireless stations 214 for determining positions of the dedicated wireless stations 214, may store current occupancy of the parking spaces of the parking structure, and so on.

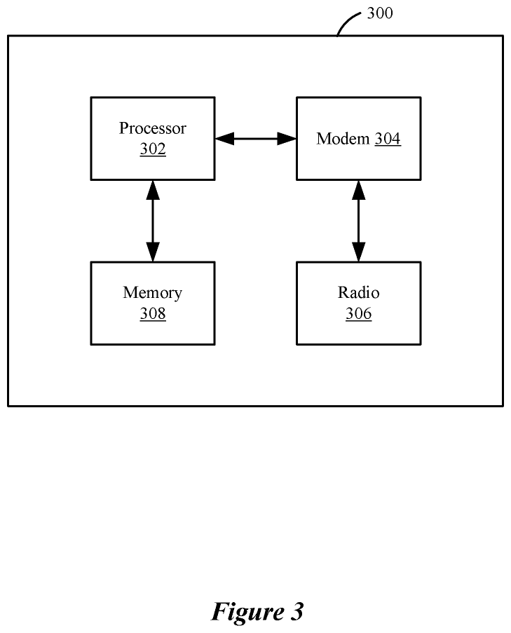

FIG. 3 shows a block diagram of an example wireless communication device 300. In some implementations, the wireless communication device 300 can be an example of a device for use in a STA such as one of the STAs 104 described above with reference to FIG. 1, or one of the dedicated wireless stations 214 of FIG. 2. In some implementations, the wireless communication device 300 can be an example of a device for use in an AP such as the AP 102 described above with reference to FIG. 1. The wireless communication device 300 is capable of transmitting and receiving wireless communications in the form of, for example, wireless packets. For example, the wireless communication device can be configured to transmit and receive packets in the form of physical layer convergence protocol (PLCP) protocol data units (PPDUs) and medium access control (MAC) protocol data units (MPDUs) conforming to an IEEE 802.11 wireless communication protocol standard, such as that defined by the IEEE 802.11-2016 specification or amendments thereof including, but not limited to, 802.11ay, 802.11ax, 802.11az, 802.11ba and 802.11be.

The wireless communication device 300 can be, or can include, a chip, system on chip (SoC), chipset, package or device that includes one or more modems 302, for example, a Wi-Fi (IEEE 802.11 compliant) modem. In some implementations, the one or more modems 302 (collectively “the modem 302”) additionally include a WWAN modem (for example, a 3GPP 4G LTE or 5G compliant modem). In some implementations, the wireless communication device 300 also includes one or more processors, processing blocks or processing elements 304 (collectively “the processor 304”) coupled with the modem 302. In some implementations, the wireless communication device 300 additionally includes one or more radios 306 (collectively “the radio 306”) coupled with the modem 302. In some implementations, the wireless communication device 300 further includes one or more memory blocks or elements 308 (collectively “the memory 308”) coupled with the processor 304 or the modem 302.

The modem 302 can include an intelligent hardware block or device such as, for example, an application-specific integrated circuit (ASIC), among other examples. The modem 302 is generally configured to implement a PHY layer, and in some implementations, also a portion of a MAC layer (for example, a hardware portion of the MAC layer). For example, the modem 302 is configured to modulate packets and to output the modulated packets to the radio 304 for transmission over the wireless medium. The modem 302 is similarly configured to obtain modulated packets received by the radio 304 and to demodulate the packets to provide demodulated packets. In addition to a modulator and a demodulator, the modem 302 may further include digital signal processing (DSP) circuitry, automatic gain control (AGC) circuitry, a coder, a decoder, a multiplexer and a demultiplexer. For example, while in a transmission mode, data obtained from the processor 306 may be provided to an encoder, which encodes the data to provide coded bits. The coded bits may then be mapped to a number N_{SS} of spatial streams for spatial multiplexing or a number N_{STS} of space-time streams for space-time block coding (STBC). The coded bits in the streams may then be mapped to points in a modulation constellation (using a selected MCS) to provide modulated symbols. The modulated symbols in the respective spatial or space-time streams may be multiplexed, transformed via an inverse fast Fourier transform (IFFT) block, and subsequently provided to the DSP circuitry (for example, for Tx windowing and filtering). The digital signals may then be provided to a digital-to-analog converter (DAC). The resultant analog signals may then be provided to a frequency upconverter, and ultimately, the radio 304. In implementations involving beamforming, the modulated symbols in the respective spatial streams are precoded via a steering matrix prior to their provision to the IFFT block.

While in a reception mode, the DSP circuitry is configured to acquire a signal including modulated symbols received from the radio 304, for example, by detecting the presence of the signal and estimating the initial timing and frequency offsets. The DSP circuitry is further configured to digitally condition the signal, for example, using channel (narrowband) filtering and analog impairment conditioning (such as correcting for I/Q imbalance), and by applying digital gain to ultimately obtain a narrowband signal. The output of the DSP circuitry may then be fed to the AGC, which is configured to use information extracted from the digital signals, for example, in one or more received training fields, to determine an appropriate gain. The output of the DSP circuitry also is coupled with a demultiplexer that demultiplexes the modulated symbols when multiple spatial streams or space-time streams are received. The demultiplexed symbols may be provided to a demodulator, which is configured to extract the symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits may then be descrambled and provided to the MAC layer (the processor 306) for processing, evaluation or interpretation.

The radio 304 generally includes at least one radio frequency (RF) transmitter (or “transmitter chain”) and at least one RF receiver (or “receiver chain”), which may be combined into one or more transceivers. For example, each of the RF transmitters and receivers may include various analog circuitry including at least one power amplifier (PA) and at least one low-noise amplifier (LNA), respectively. The RF transmitters and receivers may, in turn, be coupled to one or more antennas. For example, in some implementations, the wireless communication device 300 can include, or be coupled with, multiple transmit antennas (each with a corresponding transmit chain) and multiple receive antennas (each with a corresponding receive chain). The symbols output from the modem 302 are provided to the radio 304, which then transmits the symbols via the coupled antennas. Similarly, symbols received via the antennas are obtained by the radio 304, which then provides the symbols to the modem 302.

The processor 306 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 306 processes information received through the radio 304 and the modem 302, and processes information to be output through the modem 302 and the radio 304 for transmission through the wireless medium. For example, the processor 306 may implement a control plane and at least a portion of a MAC layer configured to perform various operations related to the generation, transmission, reception and processing of MPDUs, frames or packets. In some implementations, the MAC layer is configured to generate MPDUs for provision to the PHY layer for coding, and to receive decoded information bits from the PHY layer for processing as MPDUs. The MAC layer may further be configured to allocate time and frequency resources, for example, for OFDMA, among other operations or techniques. In some implementations, the processor 306 may generally control the modem 302 to cause the modem to perform various operations described above.

The memory 304 can include tangible storage media such as random-access memory (RAM) or read-only memory (ROM), or combinations thereof. The memory 304 also can store non-transitory processor- or computer-executable software (SW) code containing instructions that, when executed by the processor 306, cause the processor to perform various operations described herein for wireless communication, including the generation, transmission, reception and interpretation of MPDUs, frames or packets. For example, various functions of components disclosed herein, or various blocks or steps of a method, operation, process or algorithm disclosed herein, can be implemented as one or more modules of one or more computer programs.

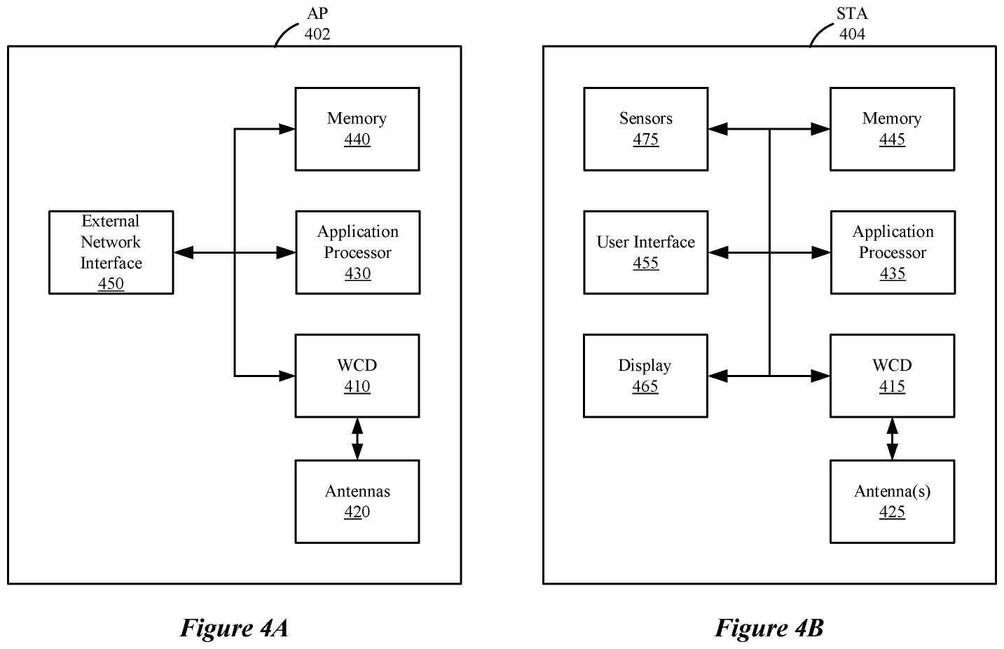

FIG. 4A shows a block diagram of an example AP 402. For example, the AP 402 can be an example implementation of the AP 102 described with reference to FIG. 1, or the AP 202 or intermediate devices 212 of FIG. 2. The AP 402 includes a wireless communication device (WCD) 410 (although the AP 402 may itself also be referred to generally as a wireless communication device as used herein). For example, the wireless communication device 410 may be an example implementation of the wireless communication device 3000 described with reference to FIG. 3. The AP 402 also includes multiple antennas 420 coupled with the wireless communication device 410 to transmit and receive wireless communications. In some implementations, the AP 402 additionally includes an application processor 430 coupled with the wireless communication device 410, and a memory 440 coupled with the application processor 430. The AP 402 further includes at least one external network interface 450 that enables the AP 402 to communicate with a core network or backhaul network to gain access to external networks including the Internet. For example, the external network interface 450 may include one or both of a wired (for example, Ethernet) network interface and a wireless network interface (such as a WWAN interface). Ones of the aforementioned components can communicate with other ones of the components directly or indirectly, over at least one bus. The AP 402 further includes a housing that encompasses the wireless communication device 410, the application processor 430, the memory 440, and at least portions of the antennas 420 and external network interface 450.

FIG. 4B shows a block diagram of an example STA 404. For example, the STA 404 can be an example implementation of the STA 104 described with reference to FIG. 1, or one of the dedicated wireless stations 214 of FIG. 2. The STA 404 includes a wireless communication device 415 (although the STA 404 may itself also be referred to generally as a wireless communication device as used herein). For example, the wireless communication device 415 may be an example implementation of the wireless communication device 300 described with reference to FIG. 3. The STA 404 also includes one or more antennas 425 coupled with the wireless communication device 415 to transmit and receive wireless communications. The STA 404 additionally includes an application processor 435 coupled with the wireless communication device 415, and a memory 445 coupled with the application processor 435. In some implementations, the STA 404 further includes a user interface (UI) 455 (such as a touchscreen or keypad) and a display 465, which may be integrated with the UI 455 to form a touchscreen display. In some implementations, the STA 404 may further include one or more sensors 475 such as, for example, one or more inertial sensors, accelerometers, temperature sensors, pressure sensors, or altitude sensors. Ones of the aforementioned components can communicate with other ones of the components directly or indirectly, over at least one bus. The STA 404 further includes a housing that encompasses the wireless communication device 415, the application processor 435, the memory 445, and at least portions of the antennas 425. UI 455, and display 465.

As described above, large parking structures are increasingly common. For example, large parking structures are common in city centers, shopping centers, train stations, airports, and other locations. As the size of such structures increases, users may find navigation from an entrance to an empty parking space increasingly difficult, especially when a parking structure is nearly full. Additionally, the use of satellite (e.g., GPS) or cellular navigation may be unavailable, as parking structures may be underground, or may otherwise inaccessible to such techniques, for example because satellite or cellular signals cannot reach the interior of the parking structure. It would therefore be desirable to simplify user positioning and navigation to empty parking spaces of a parking structure.

Various aspects relate generally to the use of mesh networking to identify a position of a station (STA) located within a vehicle within a parking structure or lot based on the strengths of signals received from nearby access points (APs) of a mesh network, and to provide navigation aid to the STA to direct it and the vehicle towards an empty space in the parking structure or area. In some examples, the STA may be a special purpose STA configured for positioning and navigation within parking structures or areas. For example, a user may be provided with such a special purpose STA upon entry to the parking structure or area, in order to aid the user in identifying and navigating to an empty parking space within the parking structure or area. In some examples, the STA determines the position based on measuring received signal strength indications (RSSIs) of signals received from a plurality of APs nearby the STA in the parking structure or area. In some other examples, a central AP of the plurality of APs may determine the position of the STA based on the RSSIs measured by the STA. In some such examples, the STA or the central AP may compare a set of RSSIs measured by the STA (an “RSSI signature”) to a number of sets of reference RSSI measurements (where each set may be referred to herein as a “reference RSSI signature”) in order to identify the position of the STA. In some examples, the position may be expressed in terms of grid coordinates, within a grid of positions. Further, each reference RSSI signature is associated with a specific position which may be defined with respect to the grid of positions. That is, each reference RSSI signature includes a plurality of RSSI measurements each of which are associated with grid coordinates indicating the specific position. In some such examples, the STA or the central AP determines the position of the STA as the grid coordinates associated with the reference RSSI signature having the smallest Euclidean distance from the RSSIs measured by the STA. The STA may then present navigation instructions, or cause a display within the vehicle to display directions, such as directions for navigating to an empty parking space or to an exit of the parking structure or lot.

Particular aspects of the subject matter described in this disclosure can be implemented to realize one or more of the following potential advantages. In some examples, the described techniques can be used to provide increased efficiency and effectiveness to the process of parking a vehicle in a parking structure by identifying open parking spaces near the vehicle and providing navigation directions to the open parking spaces. This may limit the amount of time a user of the vehicle may drive around within the parking structure, saving the user time, and reducing traffic for other users within the parking structure. Further, aspects of the present disclosure may allow for such navigation even in the absence of satellite or cellular navigation, as often a STA may be unable to receive satellite or cellular signals within a large parking structure.

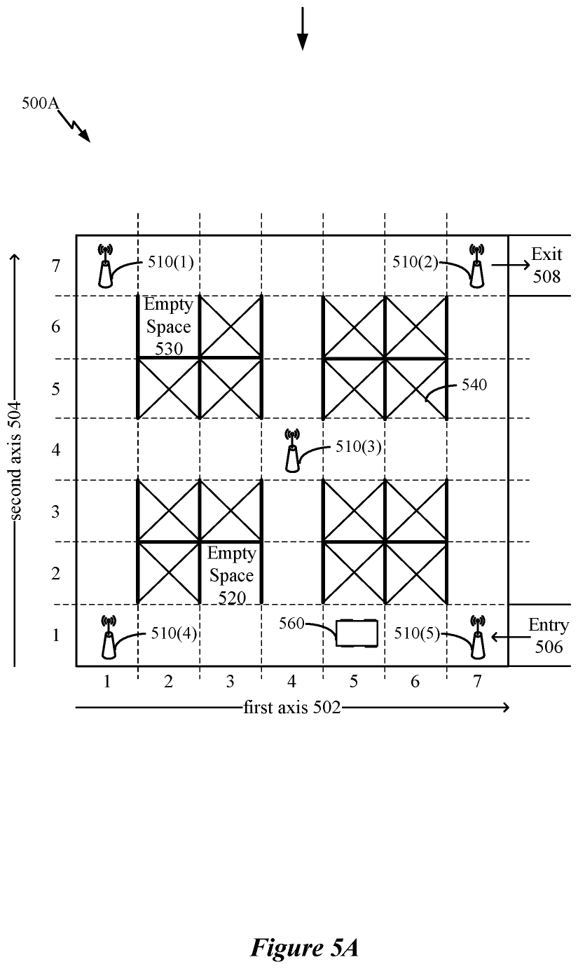

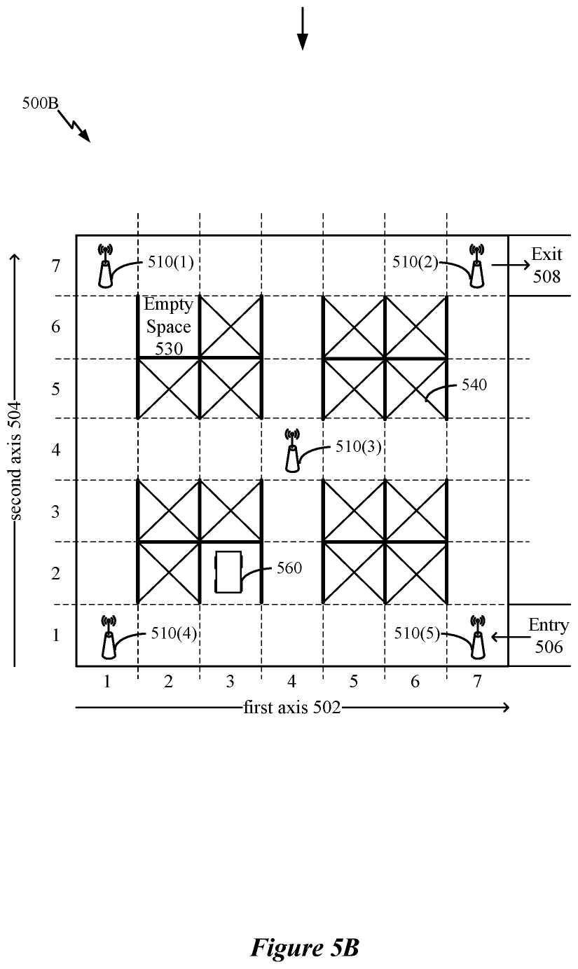

FIG. 5A shows a simplified overhead view of a parking area 500A, in accordance with the example implementations. For example, parking area may represent all or a portion of one level of a parking structure. The parking area 500A is shown to be divided into a two dimensional grid of positions, such that positions within the grid may be represented by a unique coordinate within the parking area 500A. More particularly, each position within the grid may correspond to a single coordinate along a first axis 502 ranging from 1 through 7, and a single coordinate along a second axis 504 also ranging from 1 through 7. Note that while parking area 500A is shown to be roughly square, that in other implementations parking areas may have other sizes and respective shapes. Similarly, while each position in the grid is shown to be square in the parking area 500A, this is for simplicity only, and the positions in the grid may generally be rectangular. For example, a grid position may be roughly the size of a parking space within the parking area 500A. Additionally, while each position in the grid of parking area 500A is shown to be of equal size, that in some other implementations the positions in the grid may have differing sizes depending on their use. For example, a grid representing a parking space may have one size, while grid positions representing lanes for traffic may have a different size. Similarly, parking spaces within the parking area 500A may have differing sizes, and their positions within the grid may also be different. For example, a parking space may be designated for compact cars and have a smaller than average size, while another parking space may be designated for disabled persons and therefore have a larger than average size.

The parking area 500A may also have at least one entry 506, and at least one exit 508. The entry 506 and the exit 508 may be a respective entrance to and exit from the entire parking structure or may connect to other portions of a level of the parking structure, to other levels of the parking structure, and so on. The entry 506 allows vehicles entering the parking area 500A to enter at coordinates (7,1), where 7 is the coordinate along the first axis 502, and 1 is the coordinate along the second axis 504. Similarly, the exit 508 allows vehicles to exit the parking area 500A from coordinates (7,7).

The parking area 500A is shown to include a number of parking spaces, 14 parking spaces 540, which are occupied, and marked with an X, and two empty parking spaces empty space 520 at coordinates (3,2), and empty space 530 at coordinates (2,6). The parking area 500A is also shown to include traffic lanes between and surrounding the parking spaces. For example, the parking area 500A includes three horizontal traffic lanes: a first horizontal traffic lane extending between coordinates (1,1) and (7,1); a second horizontal traffic lane extending between coordinates (1,4) and (7,4); and a third horizontal traffic lane extending between coordinates (1,7) and (7,7). Similarly, the parking area 50A is shown to include three vertical traffic lanes: a first vertical traffic lane extending between coordinates (1,1) and (1,7); a second vertical traffic lane extending between coordinates (4,1) and (4,7); and a third vertical traffic lane extending between coordinates (7,1) and (7,7).

In order to determine the position of vehicles within the parking area 500A, a STA is located within each vehicle. For example, a special purpose STA may be provided to a vehicle upon entry to the parking area 500A or to a parking structure containing the parking area 500A. Despite the fact that most people may already carry a STA, such as a cellular phone or a tablet, with them when entering the parking structure, it may be preferable to use special purpose STAs, as they may have known hardware and produce more reliable measurements for positioning and navigation.

The parking area 500A also includes a plurality of APs 510(1), 510(2), 510(3), 510(4), and 510(5) (collectively the “APs 510”). Note that the APs 510 are associated with a predetermined ordering, that is, 510(1)-510(5). Note that while FIG. 5A shows 5 APs 510, that in other implementations any suitable number of APs 510 may be present in a parking area. Each AP 510 may be either an agent AP or a central AP of a mesh network. For example, the agent APs may be one example of the intermediate devices 212 of FIG. 2, the wireless communication device 300 of FIG. 3, or AP 402 of FIG. 4A. Similarly, the central AP may be one example of the AP 202 of FIG. 2, the wireless communication device 300 of FIG. 3, or AP 402 of FIG. 4A. In some implementations, only one of the APs 510 is a central AP, with the remaining APs 510 being agent APs. In some implementations, the central AP may be centrally located within a parking area. For example the AP 510(3) located at coordinates (4,4) may be the central AP. In some aspects, as discussed in more detail below, the central AP may store a map of the parking area 500A, in addition to occupancy data, and signature data associated with each position within the grid of parking area 500A. The occupancy data may indicate a position of each parking space within the parking area 500A in addition to indicating whether each parking space is occupied. In some aspects, the occupancy data may also indicate a vehicle identifier associated with each occupied parking space, such as an identifier of the special purpose STA assigned to the vehicle occupying each occupied parking space.

Determining the position of a vehicle within the parking structure 500A may be based on measurements performed at the vehicle, using the special purpose STA, relating to signals received at the special purpose STA from one or more of the APs 510. Such signals may include, for example, beacons, transmitted by the APs 510. Such signals may be broadcasted periodically by the APs 510. In some aspects, the measurements may include a received signal strength indicator (RSSI) associated with each of the APs 510. In some other aspects, the measurements may include multipath structure of signals received from one or more of the APs 510, or the presence or absence of signals received from one or more of the APs 510. In some implementations, the special purpose STA may measure an RSSI associated with each AP 510 of a plurality of the APs 510, where the plurality of the APs 510 may be less than an entirety of the APs 510 due to the special purpose STA being unable to measure an RSSI associated with one or more of the APs 510. Such an ordered plurality of RSSI measurements may be called an RSSI signature. For example, for the parking area 500A, an RSSI signature may include an ordered plurality of RSSIs (RSSI(1), RSSI(2), RSSI(3), RSSI(4), RSSI(5)) corresponding respectively to the RSSIs measured from AP 510(1) through 510(5). Note that when the special purpose STA is unable to measure an RSSI associated with an AP 510, its corresponding RSSI in the RSSI signature may be zero. Similarly, in some aspects, when the RSSI associated with an AP 510 is below a predetermined threshold, its corresponding RSSI in the RSSI signature may also be zero. Determining the position of the vehicle may include comparing the RSSI signature to reference RSSI signatures associated with grid points of the parking area 500A.

In order to compare the RSSI signature to the reference RSSI signatures, the reference RSSI signatures must be determined and stored for each grid point within the parking area 500A. For example, the reference RSSI signatures may be determined and stored during setup operations for the parking area 500A. Determining the reference RSSI signature for a grid point may include first positioning a special purpose STA at a first position corresponding to the grid point. The special purpose STA may then receive signals transmitted by one or more of the APs 510. For example, the special purpose STA may identify a subset of the APs 510 from which the transmitted signals may be received and a corresponding RSSI measured. For example, the special purpose STA may determine that an RSSI can only be measured for APs 510(2) through 510(5), that is, that signals transmitted by the AP 510(1) cannot be detected, or do not have sufficient signal strength at the grid point for RSSI to be measured. In this context, insufficient signal strength may refer to a signal strength being below a predetermined threshold. An RSSI may then be measured for the signals transmitted from each AP 510 of the subset, resulting in a first RSSI signature for the first position (RSSI(1) RSSI(2) . . . RSSI(5))₁. For example, if signals transmitted by the AP 510(1) cannot be received at the grid point, such a first RSSI signature may be given as (0, RSSI(2) . . . RSSI(5))₁. In some aspects, the special purpose STA may then be moved to a second position within the same grid point, and the process may be repeated, measuring the RSSI values again, and determining a second RSSI signature (RSSI(1) . . . RSSI(5))₂. The process may be repeated any suitable number of times, and then the RSSI signatures may be combined to determine a single reference RSSI signature (RSSI_{ref}(1) . . . RSSI_{ref}(5) for the grid point. For example, the RSSI signatures measured for the grid point may be averaged to determine the reference RSSI signature for the grid point. In this manner, a reference RSSI signature may be determined for each grid point of the parking area 500A. Such reference RSSI signatures may be stored, for example in a memory in or coupled to the central AP of the APs 510.

Once the reference RSSI signatures have been measured and stored, they may be used for positioning and navigation for vehicles within the parking area 500A. For example, a vehicle 560 may enter the parking area 500A via the entry 506. In some aspects, upon entering the parking area 500A, the vehicle 560 may be provided with a special purpose STA for use while parking in the parking area 500A. Further, in some aspects, identification information for the vehicle 560 may be acquired, such as a license plate number, vehicle make, model, and color, and so on. Such identification information may be acquired for example, using one or more cameras proximate to the entry 506, and associated with the special purpose STA, such as associating the identification information with a media access control (MAC) address of the special purpose STA. The special purpose STA may then determine a current position, represented as a grid point within the parking area 500A, of the vehicle 560, and provide navigation instructions towards an empty parking space.

Determining a position of the vehicle 560 may include receiving the signals transmitted by at least a subset of the APs 510 and measuring an RSSI associated with each AP of the subset of APs 510. If a signal cannot be received from one of the APs 510, or its signal strength is below the predetermined threshold, then its corresponding RSSI may be given as zero. Thus, an RSSI signature for the vehicle 560 including an ordered plurality of RSSI measurements may be determined. This RSSI signature may then be compared with the reference RSSI signatures in order to determine the position of the vehicle 560. In some aspects, the special purpose STA may acquire the signals for measuring the RSSI values using a channel scan, which may be a fast channel scan.

More particularly, the position of the vehicle 560 may be determined based on a distance measure between the RSSI signature and the reference RSSI signatures. One example distance measure is a Euclidean distance measure, which may be given as

$$\sqrt{{\sum }_{i = i}^{n} {( {RSSI}_{vehicle} ( i ) - {RSSI}_{ref} ( i ) )}^{2}} ,$$

where RSSI_{vehicle}(i) represents the RSSI measured at the vehicle 560 associated with AP 510(i). The position of the vehicle 560 may be determined as the grid point associated with the minimum distance measure. In other words,

$${( x , y )}_{vehicle} = {argmin}_{( x , y )} \sqrt{{\sum }_{i = i}^{n} {( {RSSI}_{vehicle} ( i ) - {RSSI}_{ref ( x , y )} ( i ) )}^{2}} ,$$

where RSSI_{ref(x,y)}(i) represents the reference RSSI associated with AP 510(i) at the grid point (x,y).

In some aspects, some grid points of the parking area 500A may be discarded from consideration as the position of the vehicle 560. In some implementations, one or more grid points may be removed from consideration based on respective RSSI measurements associated with those of the APs 510 proximate to those grid points. For example, if the RSSI measured at the vehicle 560 associated with the AP 510(1) is zero, then one or more grid points proximate to the AP 510(1) may be removed from consideration, and the distance measure need not be computed for those one or more grid points. More generally, if the RSSI measured at the vehicle 560 associated with AP 510(i) is less than a threshold RSSI, then one or more grid points proximate to the AP 510(i). Removing grid points in this manner may simplify determination of the position of the vehicle 560, which may be important when a large number of vehicles are present in the parking area 500A, reducing the quite large number of computations required for determining the positions of all such vehicles, particularly as such computations may be repeated periodically in order to monitor the positions of each vehicle.

Once the position of the vehicle 560 has been determined, for example, determining that the vehicle 560 is located at the grid point (5,1), the special purpose STA in the vehicle 560 may be presented with navigation instructions to an empty parking space in the parking area 500A. The empty parking space may, for example, be a nearest empty parking space. For example, the special purpose STA in the vehicle 560 may present navigation instructions to the empty space 520, rather than the empty space 530, as empty space 520 is nearer the vehicle 560. In some implementations, the vehicle 560 may be associated with special needs information, such as a need for disabled accessible parking, or a need for a larger than average parking space. When the vehicle is associated with such special needs information, the vehicle 560 may instead be directed towards the nearest empty parking space meeting these requirements. For example, the empty space 520 may be a compact parking space which is too small for the vehicle 560, and the navigation instructions may be provided to the empty space 530, which may be more suitable for parking the vehicle 560.

The navigation instructions may direct the vehicle 560 down the traffic lanes of the parking area 500A to a suitable empty parking space. In some aspects, the navigation instructions may incorporate traffic flow information, such as information indicating that some traffic lanes are one way only, in order to direct the vehicle 560 to the empty parking space. For example, in order to direct the vehicle 560 to the empty space 520, the navigation instructions may direct the vehicle 560 leftward, to grid coordinates (4,1) and (3,1), and then to the empty space 520. In some aspects, the position of the vehicle 560 may be periodically determined, in order to monitor progress of the vehicle 560, and to update the navigation instructions. Once the position of the vehicle 560 is determined to be the empty parking space, such as the empty space 520, then the occupancy data associated with that empty parking space may be updated to reflect that the space is now occupied. Further, the occupancy data for the empty space 520 may be updated to include a reference to the identification information associated with the vehicle 560 to indicate that the vehicle 560 is occupying the (now previously) empty space 520.

In some aspects, in order to save battery power of the special purpose STA, once the vehicle 560 arrives at the empty parking space and does not move for a threshold period of time, the special purpose STA may reduce its power consumption, for example by disconnecting from a wireless network associated with the APs 510, or by entering a low power state.

When the driver of the vehicle 560 wishes to depart, aspects of the present disclosure may determine the position of the vehicle 560 as discussed above, and present navigation instructions to an exit of the parking area 500A. More particularly, the special purpose STA in the vehicle 560 may first determine that the vehicle 560 is likely to resume motion imminently. For example, the special purpose STA may detect movement, vibration, or sounds indicating that the vehicle 560 is likely to resume motion. Alternatively or in addition, a user within the vehicle 560 may select one or more buttons or interface options of the special purpose STA indicating that the user wishes to depart from the parking area 500A.

FIG. 5B shows a simplified overhead view of a parking area 500B, in accordance with the example implementations. The parking area 500B may represent the parking area 500A after the vehicle 560 has parked at the previously empty space 520. The position of the vehicle 560 may then be determined in the same manner discussed above. For example, the position of the vehicle 560 may be determined to be at the coordinates (3,2), corresponding to the empty space 520 of FIG. 5A. In response to determining that the position of the vehicle 560 is a grid point corresponding to a parking space, such as an occupied parking space associated with the vehicle 560, the special purpose STA in the vehicle 560 may present navigation instructions to an exit of the parking area 500B. For example, the navigation instructions may direct the vehicle 560, via one or more traffic lanes of the parking area 500B, to the exit 508. In some aspects, once the vehicle 560 has left the parking space, the occupancy data associated with that parking space may be updated to reflect that it is no longer occupied, and that another vehicle may be directed to the newly empty space. The position of the vehicle 560 may be determined or monitored as discussed above, and the navigation instructions correspondingly updated to direct the user to the exit 508. When the vehicle 560 reaches the exit 508, the special purpose STA may disconnect from the wireless network associated with the APs 510. In some implementations, identification information associated with the vehicle 560 may be detected, such as via one or more cameras or other sensors at the exit 508, in order to verify that the vehicle 560 has departed the parking area 500B. In some aspects, the driver of the vehicle 560 may return the special purpose STA before departing the parking area 500B.

Note that the above described positioning and navigation operations may be performed using the special purpose STA, using the central AP of the APs 510, or using both the special purpose STA and the central AP. For example, in some aspects, the special purpose STA may perform the RSSI measurements and transmit them to the central AP, which may store the reference RSSI signatures, determine the position of the vehicle 560, and provide the navigation instructions to the special purpose STA. For such aspects, the special purpose STA may have limited processing resources, and may not be capable of determining the position of the vehicle, or of storing the reference RSSI signatures. In some other aspects, the special purpose STA may also store the reference RSSI signatures, and therefore may not only perform the RSSI measurements, but also determine the position of the vehicle 560 using the reference RSSI signatures. For some such aspects, the special purpose STA may transmit the determined position of the vehicle 560 to the central AP, receive a position of an empty parking space, and then determine the navigation instructions for navigating to the empty parking space. For other such aspects, the special purpose STA may periodically transmit the position of the vehicle 560 to the central AP, and receive the navigation instructions from the central AP.

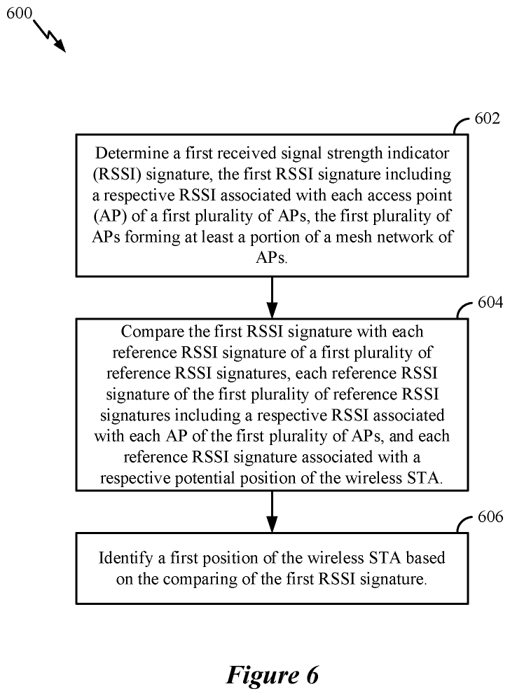

FIG. 6 shows a flowchart illustrating an example process 600 that supports wireless positioning according to some implementations. The operations of the process 600 may be implemented a wireless communication device such as the wireless communication device 300 described above with reference to FIG. 3. In some implementations, the process 600 may be performed by a wireless STA, such as by one of the stations 214 of FIG. 2, by the STA 404 of FIG. 4B, or by an AP coupled to the wireless STA, such as one of the APs 102 and 402 described above with reference to FIGS. 1 and 4A, respectively.

In some implementations, in block 602, the wireless communication device determines a first received signal strength indicator (RSSI) signature, the first RSSI signature including a respective RSSI associated with each access point (AP) of a first plurality of APs, where the first plurality of APs form at least a portion of a mesh network of APs. In some aspects, the wireless communication device is the wireless STA, and determining the first RSSI signature includes the wireless STA measuring the RSSIs associated with each AP of the first plurality of APs. In some other aspects, the wireless communication device is an AP, and determining the first RSSI signature includes receiving the RSSIs associated with each AP of the first plurality of APs from the wireless STA which measures the RSSIs.

In block 604, the wireless communication device compares the first RSSI signature with each reference RSSI signature of a first plurality of reference RSSI signatures, each reference RSSI signature of the first plurality of reference RSSI signatures including a respective RSSI associated with each AP of the first plurality of APs, and each reference RSSI signature is associated with a respective potential position of the wireless STA.

In block 606, the wireless communication device identifies a first position of the wireless STA based on the comparing of the first RSSI signature.

In some implementations, each reference RSSI signature of the first plurality of reference RSSI signatures is associated with corresponding grid coordinates within a grid of positions proximate to the first plurality of APs. In some implementations, identifying the first position of the wireless STA in block 606 includes associating the wireless STA with first grid coordinates within the grid of positions based on the comparing of the first RSSI signature. In some aspects, identifying the first position of the wireless STA in block 606 further includes determining a first reference RSSI signature of the first plurality of RSSI signatures based on the comparing of the first RSSI signature and associating the wireless STA with grid coordinates associated with the first reference RSSI signature. In some aspects, the comparing of the first RSSI signature in block 604 includes determining a Euclidean distance between the first RSSI signature and each reference RSSI signature of the first plurality of reference RSSI signatures, where the first reference RSSI signature is the reference RSSI signature having the shortest Euclidean distance from the first RSSI signature.

In some implementations, the process 600 further includes identifying second grid coordinates within the grid of positions corresponding to an empty parking space and causing the display of a navigation route from the first position of the wireless STA to the empty parking space. In some aspects, the process 600 further includes determining a second RSSI signature, the second RSSI signature including a respective RSSI associated with each AP of a second plurality of APs, the second plurality of APs forming at least a portion of the mesh network, comparing the second RSSI signature with each reference RSSI signature of a second plurality of reference RSSI signatures, each reference RSSI signature of the second plurality of reference RSSI signatures including an RSSI associated with a respective AP of the second plurality of APs, and identifying a second position of the wireless STA based on the comparing of the second RSSI signature. In some aspects, the process 600 further includes determining that the second position of the wireless STA corresponds to the second grid coordinates and setting the second grid coordinates to correspond to an occupied parking space.

In some aspects, the process 600 further includes determining that the first position of the wireless STA corresponds to an occupied parking space and causing the display of a navigation route from the first position of the wireless STA to exit coordinates within the grid of positions. In some aspects, the exit coordinates indicate an exit of a parking structure associated with the grid of positions.

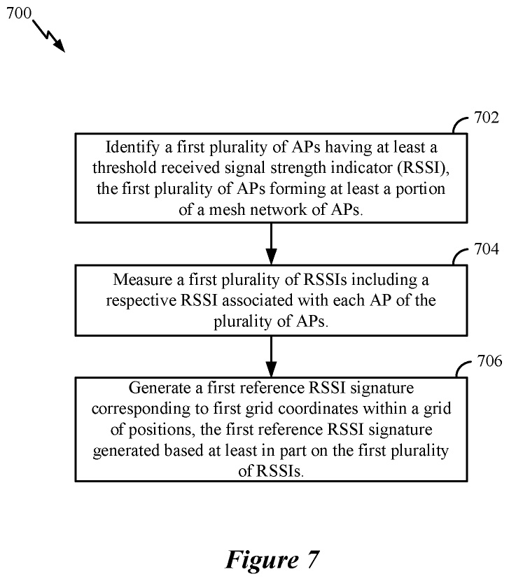

FIG. 7 shows a flowchart illustrating an example process 700 that supports generating a reference received signal strength indication (RSSI) signature according to some implementations. The process 700 may be performed by a wireless communication device such as the wireless communication device 300 described above with reference to FIG. 3. In some implementations, the process 700 may be performed by a wireless STA, such as by one of the stations 214 of FIG. 2, by the STA 404 of FIG. 4B, or by an AP coupled to the wireless STA, such as one of the APs 102 and 402 described above with reference to FIGS. 1 and 4A, respectively. The process 700 may be one method for generating each of the reference RSSI signatures which are compared in block 604 of FIG. 6.

In some implementations, in block 702, the wireless communication device identifies a first plurality of APs having at least a threshold RSSI, where the first plurality of APs form at least a portion of a mesh network of APs. At block 704, the wireless communication device measures a first plurality of RSSIs including a respective RSSI associated with each AP of the first plurality of APs. At block 706, the wireless communication device generates a first reference RSSI signature corresponding to first grid coordinates within a grid of positions, the first reference RSSI signature generated based at least in part on the first plurality of RSSIs.

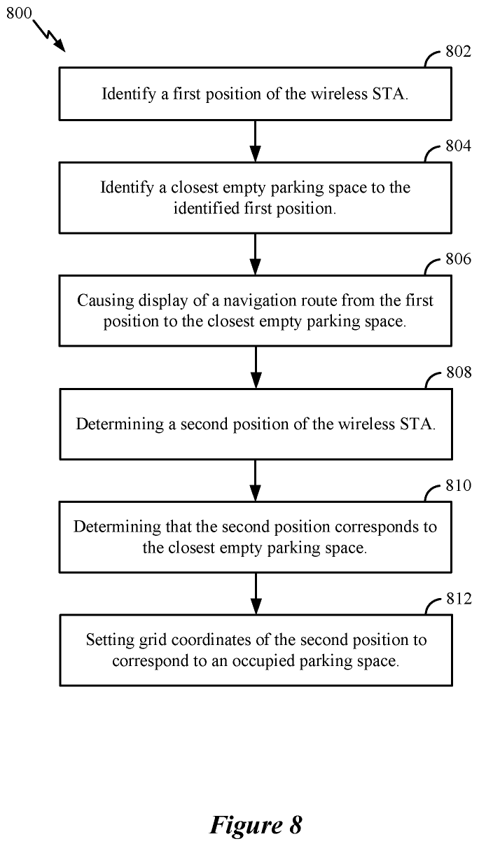

FIG. 8 shows a flowchart illustrating an example process 800 that supports positioning and navigation, according to some implementations. The process 800 may be performed by a wireless communication device such as the wireless communication device 300 described above with reference to FIG. 3. In some implementations, the process 800 may be performed by a wireless STA, such as by one of the stations 214 of FIG. 2, by the STA 404 of FIG. 4B, or by an AP coupled to the wireless STA, such as one of the APs 102 and 402 described above with reference to FIGS. 1 and 4A, respectively. The process 800 may be one method for identifying a position of a vehicle and causing navigation instructions to be displayed to an empty parking space, as discussed above with respect to FIGS. 5A and 5B.

In block 802, the wireless communication device identifies a first position of a wireless STA. For example, the first position of the wireless STA may be identified as discussed above with respect to FIGS. 5A-5B and 6. In block 804, the wireless communication device identifies a closest empty parking space to the identified first position. In block 806, the wireless communication device causes the display of a navigation route from the first position to the closest empty parking space. In block 808, the wireless communication device determines a second position of the wireless STA. IN block 810, the wireless communication device determines that the second position corresponds to the empty parking space. In block 812, the wireless communication device sets the grid coordinates of the second position to correspond to an occupied parking space.

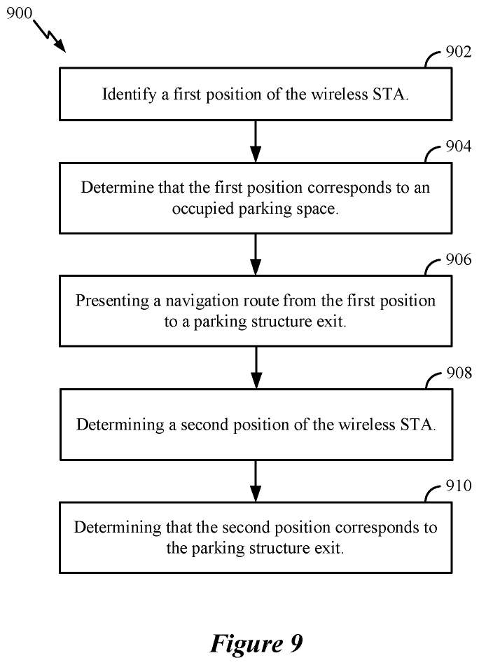

FIG. 9 shows a flowchart illustrating an example process 900 that supports positioning and navigation, according to some implementations. The process 900 may be performed by a wireless communication device such as the wireless communication device 300 described above with reference to FIG. 3. In some implementations, the process 900 may be performed by a wireless STA, such as by one of the stations 214 of FIG. 2, by the STA 404 of FIG. 4B, or by an AP coupled to the wireless STA, such as one of the APs 102 and 402 described above with reference to FIGS. 1 and 4A, respectively. The process 900 may be one method for identifying a position of a vehicle and presenting navigation instructions from a parking space to an exit of a parking structure, as discussed above with respect to FIGS. 5A and 5B.

In block 902, the wireless communication device identifies a first position of a wireless STA. For example, the first position of the wireless STA may be identified as discussed above with respect to FIGS. 5A-5B and 6. In block 904, the wireless communication device determines that the first position corresponds to an occupied parking space. In block 906, the wireless communication device presents a navigation route from the first position to a parking structure exit. In block 908, the wireless communication device determines a second position of the wireless STA. In block 910, the wireless communication device determines that the second position corresponds to the parking structure exit.

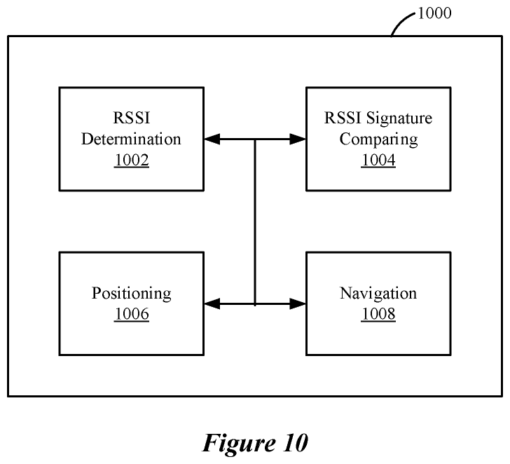

FIG. 10 shows a block diagram of an example wireless communication device 1000 that supports wireless positioning and navigation according to some implementations. In some implementations, the wireless communication device 1000 is configured to perform one or more of the processes 600-900 described above with reference to FIGS. 6-9, respectively. The wireless communication device 1000 may be an example implementation of the wireless communication device 300 described above with reference to FIG. 3. For example, the wireless communication device 1000 can be a chip, SoC, chipset, package or device that includes at least one processor (such as the processor 302), at least one modem (for example, a Wi-Fi (IEEE 802.11) modem or a cellular modem such as the modem 304), at least one memory (such as the memory 308), and at least one radio (such as the radio 306). In some implementations, the wireless communication device 1000 can be a device for use in an AP, such as one of the APs 102 and 402 described above with reference to FIGS. 1 and 4A, respectively. In some other implementations, the wireless communication device 1000 can be an AP that includes such a chip, SoC, chipset, package or device as well as at least one antenna (such as the antennas 420).

The wireless communication device 1000 includes an RSSI determination component 1002, an RSSI signature comparing component 1004, a positioning component 1006, and a navigation component 1008. Portions of one or more of the components 1002, 1004, 1006, and 1008 may be implemented at least in part in hardware or firmware. For example, the RSSI signature comparing component 1004 may be implemented at least in part by a modem (such as the modem 302). In some implementations, at least some of the components 1002, 1004, 1006, and 1008 are implemented at least in part as software stored in a memory (such as the memory 308). For example, portions of one or more of the components 1002, 1004, 1006, and 1008 can be implemented as non-transitory instructions (or “code”) executable by a processor (such as the processor 306) to perform the functions or operations of the respective module.

The RSSI determination component 1002 is configured to determine RSSIs associated with APs, such as the APs 510 of FIGS. 5A-5B or the RSSIs of the first RSSI signature determined in block 602 of FIG. 6.

The RSSI signature comparing component 1004 is configured to compare RSSI signatures including RSSIs determined from the RSSI determination component 1002 with reference RSSI signatures determined, for example, as discussed above with respect to FIGS. 5A-5B and block 604 of FIG. 6.

The positioning component 1006 is configured to determine positions of a wireless STA based on the RSS signature comparing performed by RSSI signature comparing component 1004, for example as discussed above with respect to FIGS. 5A-5B and in block 606 of FIG. 6.

The navigation component 1008 is configured to provide navigation instructions to wireless STAs based on the positions determined using the positioning component 1006, for example as discussed above with respect to FIGS. 5A-5B and FIGS. 8-9.

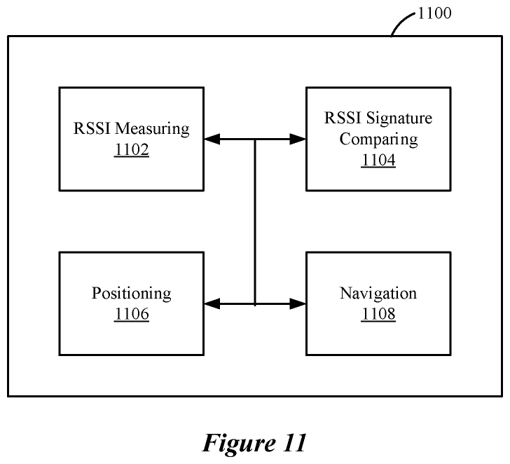

FIG. 11 shows a block diagram of an example wireless communication device 1100 that supports wireless positioning and navigation according to some implementations. In some implementations, the wireless communication device 1100 is configured to perform one or more of the processes 600-900 described above with reference to FIGS. 6-9, respectively. The wireless communication device 1100 may be an example implementation of the wireless communication device 300 described above with reference to FIG. 3. For example, the wireless communication device 1100 can be a chip, SoC, chipset, package or device that includes at least one processor (such as the processor 302), at least one modem (for example, a Wi-Fi (IEEE 802.11) modem or a cellular modem such as the modem 304), at least one memory (such as the memory 308), and at least one radio (such as the radio 306). In some implementations, the wireless communication device 1100 can be a device for use in a STA, such as one of the STAs 104 and 404 described above with reference to FIGS. 1 and 4B, respectively. In some other implementations, the wireless communication device 1100 can be a STA that includes such a chip, SoC, chipset, package or device as well as at least one antenna (such as the antennas 425).

The wireless communication device 1100 includes an RSSI measuring component 1102, an RSSI signature comparing component 1104, a positioning component 1106, and a navigation component 1108. Portions of one or more of the components 1102, 1104, 1106, and 1108 may be implemented at least in part in hardware or firmware. For example, the RSSI signature comparing component 1104 may be implemented at least in part by a modem (such as the modem 302). In some implementations, at least some of the components 1102, 1104, 1106, and 1108 are implemented at least in part as software stored in a memory (such as the memory 308). For example, portions of one or more of the components 1102, 1104, 1106, and 1108 can be implemented as non-transitory instructions (or “code”) executable by a processor (such as the processor 306) to perform the functions or operations of the respective module.

The RSSI measuring component 1102 is configured to measure RSSIs associated with APs, such as the APs 510 of FIGS. 5A-5B or the RSSIs associated with the first RSSI signature determined in block 602 of FIG. 6.

The RSSI signature comparing component 1104 is configured to compare RSSI signatures including RSSIs determined from the RSSI measuring component 1102 with reference RSSI signatures determined, for example, as discussed above with respect to FIGS. 5A-5B and block 604 of FIG. 6.

The positioning component 1106 is configured to determine positions of a wireless STA based on the RSS signature comparing performed by RSSI signature comparing component 1104, for example as discussed above with respect to FIGS. 5A-5B and in block 606 of FIG. 6.

The navigation component 1108 is configured to provide navigation instructions to wireless STAs based on the positions determined using the positioning component 1106, for example as discussed above with respect to FIGS. 5A-5B and FIGS. 8-9.

As used herein, “or” is used intended to be interpreted in the inclusive sense, unless otherwise explicitly indicated. For example, “a or b” may include a only, b only, or a combination of a and b. As used herein, a phrase referring to “at least one of” or “one or more of” a list of items refers to any combination of those items, including single members. For example, “at least one of: a, b, or c” is intended to cover the examples of: a only, b only, c only, a combination of a and b, a combination of a and c, a combination of b and c, and a combination of a and b and c.

The various illustrative components, logic, logical blocks, modules, circuits, operations, and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A method for wireless positioning by a wireless station (STA), comprising:
determining a first received signal strength indicator (RSSI) signature, the first RSSI signature comprising a respective RSSI associated with each access point (AP) of a first plurality of APs, the first plurality of APs forming at least a portion of a mesh network of APs;
comparing the first RSSI signature with each reference RSSI signature of a first plurality of reference RSSI signatures, each reference RSSI signature of the first plurality of reference RSSI signatures comprising a respective RSSI associated with each AP of the first plurality of APs, and each reference RSSI signature associated with a respective potential position of the wireless STA; and
identifying a first position of the wireless STA based on the comparing of the first RSSI signature.

2. The method of claim 1, wherein each reference RSSI signature of the first plurality of reference RSSI signatures is associated with corresponding grid coordinates within a grid of positions proximate to the first plurality of APs.

3. The method of claim 2, wherein identifying the first position of the wireless STA comprises associating the wireless STA with first grid coordinates within the grid of positions based on the comparing of the first RSSI signature.

4. The method of claim 3, wherein identifying the first position of the wireless STA comprises determining a first reference RSSI signature of the first plurality of RSSI signatures based on the comparing and associating the wireless STA with grid coordinates associated with the first reference RSSI signature.

5. The method of claim 4, wherein the comparing of the first RSSI signature comprises determining a Euclidean distance between the first RSSI signature and each reference RSSI signature of the first plurality of reference RSSI signatures, wherein the first reference RSSI signature is the reference RSSI signature having the shortest Euclidean distance from the first RSSI signature.

6. The method of claim 2, further comprising:
identifying second grid coordinates within the grid of positions corresponding to an empty parking space; and
causing a navigation route to be displayed from the first position of the wireless STA to the empty parking space.

7. The method of claim 6, further comprising:
determining a second RSSI signature, the second RSSI signature comprising a respective RSSI associated with each access point (AP) of a second plurality of APs, the second plurality of APs forming at least a portion of the mesh network of APs;
comparing the second RSSI signature with each reference RSSI signature of a second plurality of reference RSSI signatures, each reference RSSI signature of the second plurality of reference RSSI signatures comprising an RSSI associated with each AP of the second plurality of APs; and
identifying a second position of the wireless STA based on the comparing of the second RSSI signature.

8. The method of claim 7, further comprising determining that the second position of the wireless STA corresponds to the second grid coordinates and setting the second grid coordinates to correspond to an occupied parking space.

9. The method of claim 2, further comprising:
determining that the first position of the wireless STA corresponds to an occupied parking space; and
causing a navigation route to be displayed from the first position of the wireless STA to exit coordinates within the grid of positions.

10. The method of claim 9, wherein the exit coordinates indicate an exit of a parking structure associated with the grid of positions.

11. A wireless station (STA), comprising:
at least one processor; and
at least one memory communicatively coupled with the at least one processor and storing processor-readable code that, when executed by the at least one processor, is configured to cause the STA to:
determine a first received signal strength indicator (RSSI) signature, the first RSSI signature comprising a respective RSSI associated with each access point (AP) of a first plurality of APs, the first plurality of APs forming at least a portion of a mesh network of APs;
compare the first RSSI signature with each reference RSSI signature of a first plurality of reference RSSI signatures, each reference RSSI signature of the first plurality of reference RSSI signatures comprising a respective RSSI associated with each AP of the first plurality of APs, and each reference RSSI signature associated with a respective potential position of the wireless STA; and
identify a first position of the wireless STA based on the comparing of the first RSSI signature.

12. The wireless STA of claim 11, wherein each reference RSSI signature of the first plurality of reference RSSI signatures is associated with corresponding grid coordinates within a grid of positions proximate to the first plurality of APs.

13. The wireless STA of claim 12, wherein identifying the first position of the wireless STA comprises associating the wireless STA with first grid coordinates within the grid of positions based on the comparing of the first RSSI signature.

14. The wireless STA of claim 13, wherein identifying the first position of the wireless STA comprises determining a first reference RSSI signature of the first plurality of RSSI signatures based on the comparing of the first RSSI signature and associating the wireless STA with grid coordinates associated with the first reference RSSI signature.

15. The wireless STA of claim 14, wherein the comparing of the first RSSI signature comprises determining a Euclidean distance between the first RSSI signature and each reference RSSI signature of the first plurality of reference RSSI signatures, wherein the first reference RSSI signature is the reference RSSI signature having the shortest Euclidean distance from the first RSSI signature.

16. The wireless STA of claim 12, further comprising:
identifying second grid coordinates within the grid of positions corresponding to an empty parking space; and
causing a navigation route to be displayed from the first position of the wireless STA to the empty parking space.

17. The wireless STA of claim 16, further comprising:
determining a second RSSI signature, the second RSSI signature comprising a respective RSSI associated with each access point (AP) of a second plurality of APs, the second plurality of APs forming at least a portion of the mesh network;
comparing the second RSSI signature with each reference RSSI signature of a second plurality of reference RSSI signatures, each reference RSSI signature of the second plurality of reference RSSI signatures comprising a respective RSSI associated with each AP of the second plurality of APs; and
identifying a second position of the wireless STA based on the comparing of the second RSSI signature.

18. The wireless STA of claim 17, further comprising determining that the second position of the wireless STA corresponds to the second grid coordinates and setting the second grid coordinates to correspond to an occupied parking space.

19. The wireless STA of claim 12, further comprising:
determining that the first position of the wireless STA corresponds to an occupied parking space; and
causing a navigation route to be displayed from the first position of the wireless STA to exit coordinates within the grid of positions.

20. The wireless STA of claim 19, wherein the exit coordinates indicate an exit of a parking structure associated with the grid of positions.

21. The wireless STA of claim 11, further comprising:
at least one transceiver coupled to the at least one modem;
at least one antenna coupled to the at least one transceiver to wirelessly transmit signals output from the at least one transceiver and to wirelessly receive signals for input into the at least one transceiver; and
a housing that encompasses the at least one modem, the at least one processor, the at least one memory, the at least one transceiver and at least a portion of the at least one antenna.

22. A method for generating position signatures for positions within a grid of positions, the method comprising:
identifying a first plurality of access points (APs) having at least a threshold received signal strength indicator (RSSI), the first plurality of APs forming at least a portion of a mesh network of APs;
measuring a first plurality of RSSIs, the first plurality of RSSIs including a respective RSSI associated with each AP of the first plurality of APs; and
generating a first reference RSSI signature corresponding to first grid coordinates within the grid of positions, the first reference RSSI signature generated based at least in part on the first plurality of RSSIs.

23. The method of claim 22, wherein each RSSI of the first plurality of RSSIs is associated with a first position corresponding to the first grid coordinates.

24. The method of claim 22, further comprising measuring a second plurality of RSSIs, the second plurality of RSSIs including a respective RSSI associated with each AP of the first plurality of APs.

25. The method of claim 24, wherein the second plurality of RSSIs is associated with a second position corresponding to the first grid coordinates.

26. The method of claim 24, wherein the first reference RSSI signature is generated based at least in part on the second plurality of RSSIs.

27. The method of claim 25, wherein the first reference RSSI signature includes, for each respective AP of the first plurality of APs, an average of the corresponding RSSI of the first plurality of RSSIs and the corresponding RSSI of the second plurality of RSSIs.

28. The method of claim 22, further comprising:
identifying a third plurality of access points (APs) having at least the threshold RSSI, the third plurality of APs forming at least a portion of the mesh network;
measuring a third plurality of RSSIs, the third plurality of RSSIs including a respective RSSI associated with each AP of the third plurality of APs; and
generating a second reference RSSI signature corresponding to second grid coordinates within the grid of positions, the second reference RSSI signature generated based at least in part on the third plurality of RSSIs.

29. The method of claim 28, wherein each RSSI of the third plurality of RSSIs is associated with a third position corresponding to the second grid coordinates.

30. The method of claim 22, wherein the first reference RSSI signature includes a value of zero corresponding to each AP of the mesh network of APs not having at least the threshold RSSI.
